(19) United States
(12) Patent Application Publication
(10) Pub. No.: US 2011/0051185 A1
(43) Pub. Date: Mar. 3, 2011

(54) COMPUTER READABLE INFORMATION RECORDING MEDIUM AND INFORMATION PROCESSING APPARATUS

(75) Inventor: Teruaki TAKAHASHI, Saitama (JP)

(73) Assignee: RICOH COMPANY, LTD., Tokyo (JP)

(21) Appl. No.: 12/860,227

(22) Filed: Aug. 20, 2010

(30) Foreign Application Priority Data
Aug. 28, 2009 (JP) 2009-198515

(51) Int. Cl. G06F 3/12

(52) U.S. Cl. 358/1.15

(57) ABSTRACT

A program, when executed by a computer processor, carries out setting, for a printing request that is obtained from a printer driver, output destination information used to identify an output destination to which the printing request is output; determining whether a printing port that corresponds to the output destination information that has been set exists based on port management information that associates the printing port with the output destination information; creating a printing port when the determining determines that no printing port that corresponds to the output destination information exists; and storing in job management information the printing port that corresponds to the output destination information or the created printing port, the printing request and the output destination information in such a manner that the printing port, the printing request and the output destination information are associated with each other.

### BACKGROUND OF THE INVENTION

1. Field of the Invention

The present invention relates to a computer readable information recording medium and an information processing apparatus.

2. Description of the Related Art

Recently, for a user who uses a notebook-type PC (Personal Computer) and moves to respective branch offices or respective floors, a printing system by which a printer can be freely selected is demanded. For this purpose, as to a printer driver (software), an art exists by which a screen page for designating a printer from which a printing output is carried out is displayed, and printers (output destinations) introduced to respective positions can be selected by using the single printer driver. That is, the screen page is displayed each time of printing and an output destination can be selected by using the screen page so that the output destination can be easily changed.

For example, Japanese Patent No. 3484816 (Patent Document 1) discloses an art by which even as a result of a desired printer being selected from among plural printers existing in a communication network, and predetermined setting input and printing instruction request operation being carried out from a printing instruction operation panel, switching between the plural printers of the communication network can be easily carried out.

However, in such a type of related art, it may not be possible to switch the output destination during a printing operation because of limitations of operations of a port monitor (software) that is provided by an OS (Operation System). It is noted that the port monitor is a module used by the printer driver for the purpose of outputting printing data to an apparatus that actually carries out the printing output. Because of limitations of operations of the port monitor, it may not be possible to change the output destination while printing a document having a very large size, and it may be necessary to wait for a finish of an immediate preceding printing operation of a document when the output destination is to be switched for every document to print. This may be because a single printing port is used for plural printing jobs, and because of using the single printing port, it may not be possible to manage an output destination for any printing job.

### SUMMARY OF THE INVENTION

The present invention has been devised in consideration of the problem, and an object of the present invention is to provide a computer readable information recording medium and an information processing apparatus by which, as a result of a printing job and a printing port being associated with one another, an output destination of any printing job can be managed.

According to one aspect of the present invention, a non-transitory computer readable information recording medium stores a program, and the program, when executed by a computer processor, carries out setting, for a printing request that is obtained from a printer driver, output destination information used to identify an output destination to which the printing request is output; determining whether a printing port that corresponds to the output destination information that has been set exists based on port management information that associates the printing port with the output destination information; creating a printing port when the determining determines that no printing port that corresponds to the output destination information exists; and storing in job management information the printing port that corresponds to the output destination information or the created printing port, the printing request and the output destination information in such a manner that the printing port, the printing request and the output destination information are associated with each other.

According to another aspect of the present invention, an information processing apparatus in which a printer driver is installed, includes a setting part that sets, for a printing request that is obtained from the printer driver, output destination information used to identify an output destination to which the printing request is output; a determination part that determines whether a printing port that corresponds to the output destination information exists based on port management information that associates the printing port with the output destination information; a storage part that stores job management information in which the printing port, the printing request and the output destination information are associated with each other; and a creation part that creates a printing port when the determination part determines that no printing port that corresponds to the output destination information exists. The storage part stores in the job management information the printing port that corresponds to the output destination information or the created printing port, the printing request and the output destination information in such a manner the printing port, the printing request and the output destination information are associated with each other.

Other objects, features and advantages of the present invention will become more apparent from the following detailed description when read in conjunction with the accompanying drawings.

### BRIEF DESCRIPTION OF THE DRAWINGS

FIG. 1 shows one example of a system configuration and a hardware configuration of an information processing apparatus in an embodiment 1;

FIG. 2 shows a concept of an output destination changing application;

FIG. 3 illustrates a concept of an output destination changing application in the embodiment 1;

FIG. 4 shows a block diagram of one example of a functional configuration of the information processing apparatus in the embodiment 1;

FIG. 5 shows one example of an output destination setting screen page;

FIG. 6 shows one example of job management information;

FIG. 7 shows one example of port management information;

FIG. 8 shows one example of a printing port management screen page;

FIG. 9 shows a flowchart of one example of an adding process for job management information in the embodiment 1;

FIG. 10 shows a flowchart of one example of a printing port address changing process in the embodiment 1; and

FIG. 11 shows a flowchart of one example of a printing port changing process in the embodiment 1.

### DETAILED DESCRIPTION OF THE EMBODIMENTS

Below, the embodiment 1 of the present invention will be described based on the figures.

### <System Configuration and Hardware Configuration>

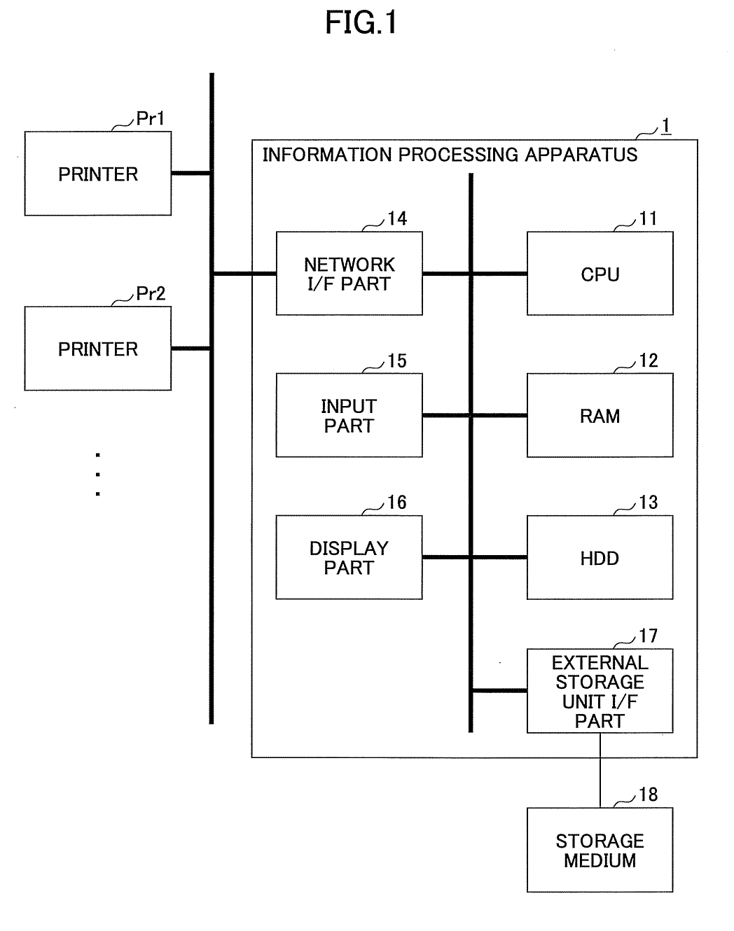

First, a system configuration and a hardware configuration of the information processing apparatus in the embodiment 1 of the present invention will be described. FIG. 1 shows one example of a system configuration and a hardware configuration of the information processing apparatus in the embodiment 1.

As shown in FIG. 1, an image processing system in the embodiment 1 of the present invention is such that the information processing apparatus 1 is connected with printer apparatuses Pr1, Pr2, . . . via a communication network. The printer apparatuses Pr1, Pr2, . . . print printing data received from the information processing apparatus 1. The printer apparatuses Pr1, Pr2, . . . include image forming apparatuses.

The information processing apparatus 1 includes a CPU (Central Processing Unit) 11, a RAM (Random Access Memory) 12, a HDD (Hard Disk Drive) 13, a network I/F (InterFace) part 14, an input part 15, a display part 16 and an external storage unit I/F (InterFace) part 17.

The CPU 11 carries out control of the respective parts of the information processing apparatus 1 and calculation/modification of data. The CPU 11 acts as an arithmetic and logic unit, carries out programs stored by the RAM 12, receives data from the input part 15, the RAM 12, the HDD 13 or a storage medium 18 via the external storage unit I/F part 17, carries out a calculation, a logic operation or a modification, and then, outputs the result to the display part 16, the RAM 12, the HDD 13 or the storage medium 18 via the external storage unit I/F part 17.

The RAM 12 stores the OS that is basic software, programs such as application software executed by the CPU 11, and data.

The HDD 13 stores data concerning the application software or such.

The network I/F part 14 provides an interface between the information processing apparatus 1 and the printer apparatuses Pr1, Pr2, . . . that have communication functions and are connected via the communication network (for example, Ethernet (registered trademark)) such as a LAN (Local Area Network), a WAN (Wide Area Network) established by using a data transmission path such as a wired communication path and/or a wireless communication path.

The input part 15 includes a keyboard that includes a cursor key, a ten-key, various functional keys and so forth, a mouse or a slice pad that is used to, for example, select a key on a display screen of the display part 16, or such. The input part 15 provides a user interface for a user to give an operation instruction to the CPU 11 or input data.

The display part 16 includes a CRT (Cathode-Ray Tube), a LCD (Liquid Crystal Display) or such, and carries out a display according to display data given by the CPU 11.

The external storage unit I/F part 17 provides an interface between the storage medium 18 (for example, a flash memory) and the information processing apparatus 1 connected by using a data transmission path such as a USB (Universal Serial Bus).

Further, a predetermined program is stored by the storage medium 18, the predetermined program is then installed in the information processing apparatus 1 from the storage medium 18 via the external storage unit I/F part 17, and the installed predetermined program is executable by the information processing apparatus 1.

The information processing apparatus 1 is, for example, a PC (Personal Computer). In the example of FIG. 1, the single information processing apparatus 1 and the plural printer apparatuses Pr1, Pr2, . . . are connected. However, the number of the information processing apparatuses 1 and the number of the printer apparatuses Pr1, Pr2, . . . are not limited to those of the example.

### <Concept of Output Destination Changing Application>

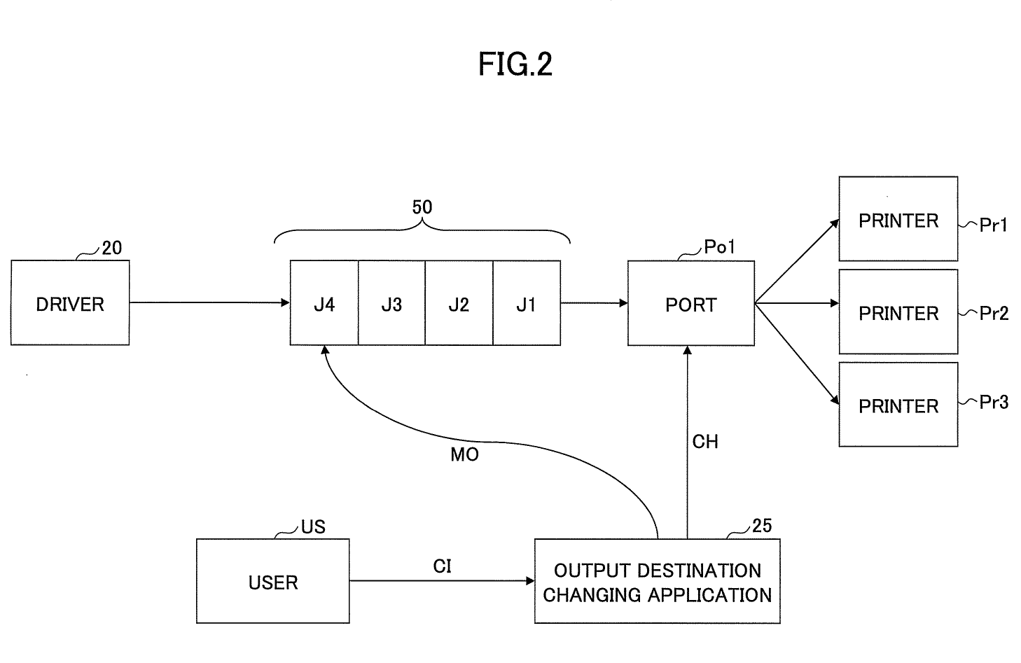

Next, a concept of an output destination changing application will be described. FIG. 2 illustrates a concept of an output destination changing application 25. As shown in FIG. 2, a printer driver 20 converts image information that is generated by an application (program) into a page description language that is recognizable by the printer apparatuses Pr1, Pr2 and Pr3 when the image information is printed.

When a user inputs a printing execution instruction, the printer driver 20 outputs a corresponding printing job (which may also be referred to as a printing request) to a print queue 50. The print queue 50 is a buffer that operates according to FIFO (First-In First-Out method). Next, the printing job stored by the print queue 50 is output to the printer apparatus Pr1, Pr2 or Pr3 (also referred to as an output destination) having an IP (Internet Protocol) address that is set in a printing port Po1. The printing port Po1 is a storage area of a storage device to store the IP address of the printer apparatus Pr1, Pr2 or Pr3, to provide information indicating the output destination. For the purpose of responding to an external query, identifiers (job IDs) such as J1, J2, J3 and J4 are given to the printing jobs.

It is noted that the output destination changing application (program) 25 is an application that operates asynchronously from a printing process to print given image information. The output destination changing application 25 monitors (MO) the print queue 50, and changes (CH) the IP address that is set in the printing port Po1. It is noted that because of limitations of the OS in the example of FIG. 2, only one printing port can be set for the print queue 50, and therefore, the printer apparatus Pr1, Pr2 or Pr3 is switched as a result of the IP address in the printing port Po1 being changed.

In a case where a user US inputs an instruction (CI) to change the IP address in the printing port Po1 by using the output destination changing application 25, printing data may be output to a printer apparatus Pr1, Pr2 or Pr3 that is not one which the user actually wishes because of the timing of the input operation. Further, such a problem may occur that printing is not carried out properly because the IP address is changed during the printing operation.

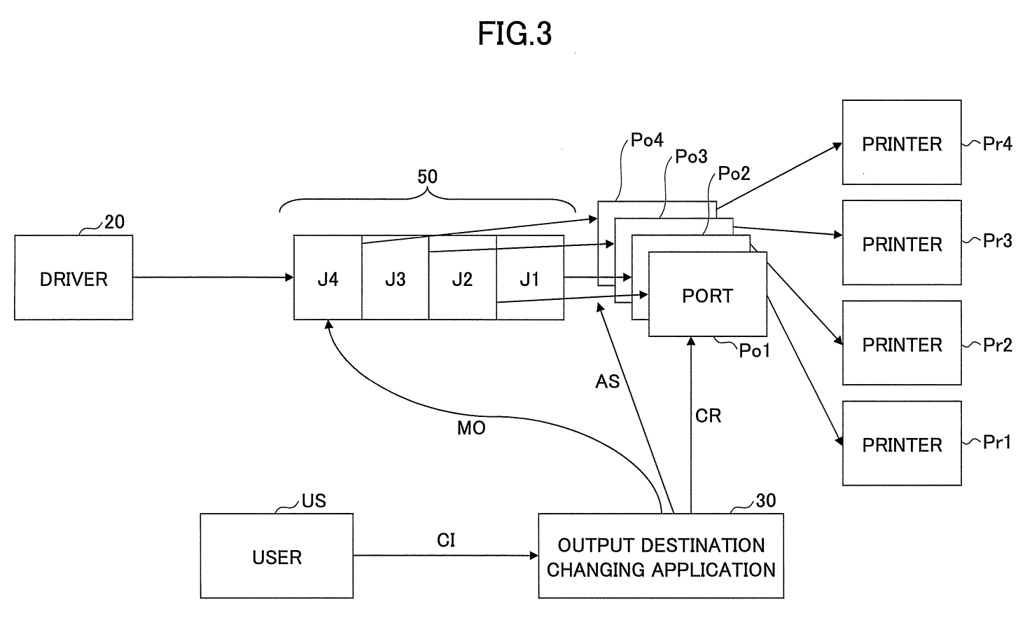

Next, a concept of an output destination changing application 30 according to the embodiment 1 of the present invention that solves the above-mentioned problem will be described. FIG. 3 illustrates a concept of an output destination changing application 30 according to the embodiment 1.

In an example of FIG. 3, the output destination changing application 30 creates (CR) a printing port Po1 when no printing port is set for an IP address that is designated by a user US, and associates the created printing port Po1 with the IP address. Further, the output destination changing application 30 associates the printing ports Po1, Po2, Po3 and Po4 with printing jobs J2, J1, J3 and J4, respectively, and manages the printing ports Po1, Po2, Po3 and Po4 for the respective printing jobs J2, J1, J3 and J4.

Thus, the output destination changing application 30 recognizes a relationship between the printing jobs J2, J1, J3 and J4 and the printing ports Po1, Po2, Po3 and Po4, and therefore, the user US can determine which printing job is output to which printing apparatus by reading the relationship from the display part 16.

Further, as a result of the output destination changing application 30 changing the IP address corresponding to the printing port at any time, it is possible to output the printing job to which the printing port is set to the printer apparatus indicated by the changed IP address. Further, as a result of the output destination changing application 30 switching the printing port corresponding to the printing job at any time, it is possible to output only the printing job to the output destination by using the changed printing port.

### <Functional Configuration>

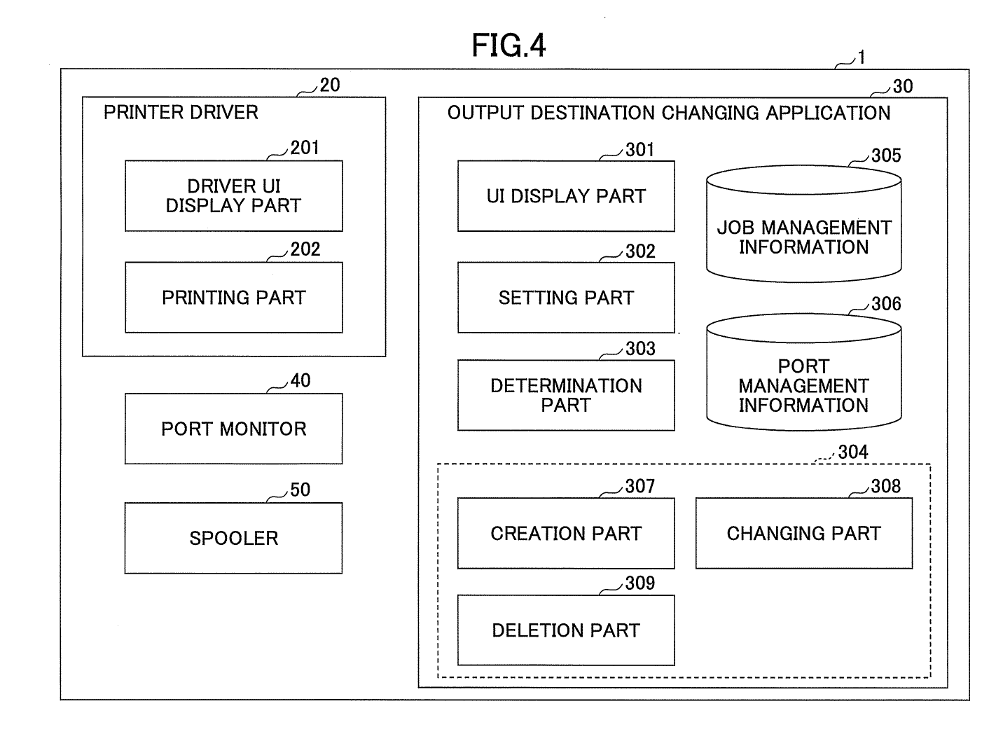

FIG. 4 is a block diagram showing one example of a functional configuration of the information processing apparatus 1 in the embodiment 1. As shown in FIG. 4, the information processing apparatus 1 includes the printer driver 20 (software), the output destination changing application 30 (software), a port monitor 40 (software) and a spooler 50 (buffer).

The printer driver 20 converts image information that is generated by an application (program) into a page description language that is recognizable by the printer apparatus when the printer apparatus prints the image information. Further, the printer driver 20 outputs the converted page description language to the spooler 50 first. Further, the printer driver 20 assumes that plural printer apparatuses are used to carry out printing from a single printer driver. For example, the printer driver 20 is a printer driver (for example, a mobile printer driver) prepared to carry out printing by using printer apparatuses installed in an office from a mobile environment such as a notebook-type PC.

Specifically, the printer driver 20 includes a driver UI display part 201 and a printing part 202. The driver UI display part 201 displays a printing setting screen page on the display part 16, and receives a printing setting from the user.

The printing part 202 converts printing data given by an application (program) into a PDL (Page Description Language) and outputs the converted printing data together with the printing setting to the spooler 50.

The output destination changing application (output destination changing part) 30 changes the output destination that is set in the port monitor 40 in response to an instruction from the user or such. For the purpose of changing the output destination, the output destination changing application 30 notifies the port monitor 40 of the printing port to be changed and/or the IP address to be changed or such.

Further, the output destination changing application 30 includes a UI display part 301, a setting part 302, a determination part 303, a port management part 304, job management information 305 (stored by the RAM 12, for example), and port management information 306 (stored by the RAM 12, for example).

The UI display part 301 displays an output destination setting screen page on the display part 16 for the user to input the output destination even when the printer driver 20 is not started up.

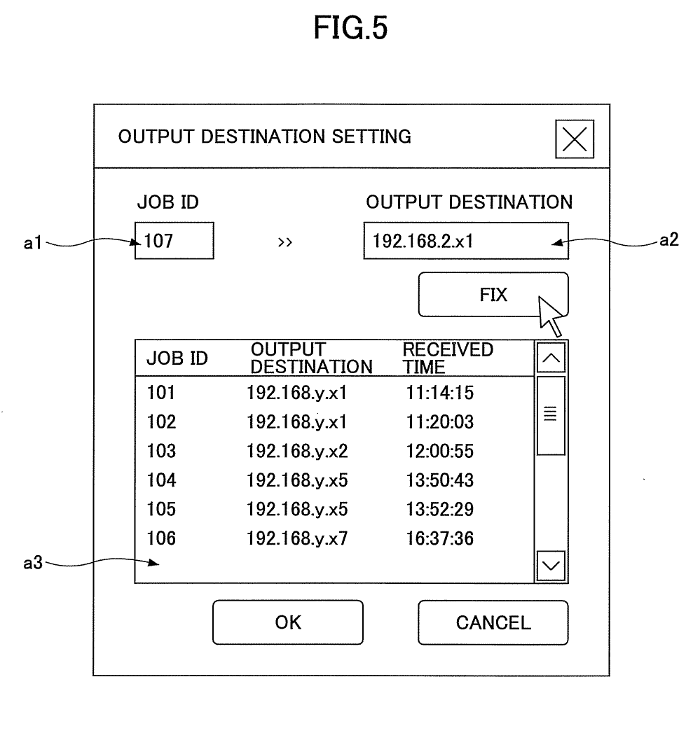

The setting part 302 receives a setting of the output destination for the printing job that is newly generated from the output destination setting screen page shown in FIG. 5. FIG. 5 shows one example of the output destination setting screen page. Since the output destination changing application 30 is application software that is asynchronous from a printing process of the operation system, it is possible to change the output destination of the printing job at any time by using the output destination changing application 30.

However, as to the printing job during a printing process, the output destination should not be changed because an error may occur or the printing job may be transmitted to plural printer apparatuses that the user does not wish when the output destination is changed. Therefore, the UI display part 301 does not display information concerning the printing job during a printing process. It is noted that the output destination setting screen page is generated based on the job management information 305.

In the example shown in FIG. 5, when the user inputs in an output destination edit box a2 the output destination for the printing job that is displayed in a job ID edit box a1, and presses a fix button (“FIX”), the setting part 302 receives the job ID of the printing job and the address of the output destination, and stores them in the job management information 305. Thus, the job ID, the output destination information used to identify the output destination, the printing port corresponding to the output destination information and the received time at which the printing job was received are added to the job management information 305. In response thereto, the job ID, the output destination information and the received time are added also to a display area a3. At this time, it is determined whether there is the printing port corresponding to the address of the output destination (output destination information) that is thus input. This determination process will be described later.

In the example of FIG. 5, the user intends to set the output destination “192.168.2.x1” for the printing job having the job ID “107” which is newly generated. In this state, when the user presses the fix button “FIX”, the information indicating the newly generated printing job is registered and displayed to the bottom of the display area a3.

Further, when the user presses an “OK” button shown in FIG. 5, the printing process is started. Thereby, the printing jobs stored by the spooler 50 are transmitted to the output destinations via the corresponding printing ports in sequence. When the user presses a “CANCEL” button shown in FIG. 5, the printing process is started. However, in this case, as for the newly generated printing job, the output destination is not designated, and a default output destination is set for the newly generated printing job.

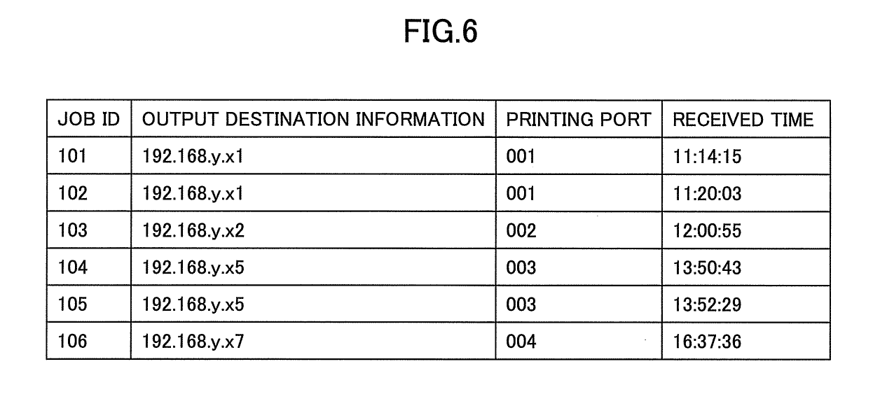

FIG. 6 shows one example of the job management information 305. As shown in FIG. 6, the job management information 305 includes the job IDs, the IP addresses of the output destination (output destination information), the printing ports and the received times in such a manner that they are associated with each other. The output destination changing application 30 monitors the spooler 50 corresponding to the above-mentioned print queue 50 to obtain the information of the printing jobs.

Next, the setting part 302 sets the thus-obtained output destination corresponding to the printing job, and associates the printing port that corresponds to the output destination with the output destination. It is noted that one printing port is associated with one IP address.

Further, information included in the job management information 305 is displayed in the output destination setting screen page shown in FIG. 5. In the output destination setting screen page, the printing ports may also be displayed.

Further, as shown in FIG. 6, the job management information 305 may include the information of the printing jobs that currently wait for a printing process in an editable list form. Based on the output destinations that are thus input from the output destination setting screen page, the printing ports corresponding to the output destinations are created and managed by the operating system. The printing ports are storage areas (of the RAM 12, for example) to store the respective IP addresses to provide information indicating the corresponding output destinations.

Further, when the printing process is started, the printing jobs are transmitted to the output destinations in sequence in the order of the received times as the printing job having the earlier received time is transmitted faster. In the example shown in FIG. 6, the six printing jobs (job IDs: “101” through “106”) which wait for a printing process exist, and the printing jobs are transmitted to the output destinations in sequence starting from the printing job of the job ID “101”.

The determination part 303 determines whether the output destination information indicating the output destination received by the setting part 302 already exists in the port management information 306. When the output destination information already exists in the port management information 306, the determination part 303 stores in the job management information 305 the printing port corresponding to the output destination information while associating the printing port with the printing job.

Further, when the output destination information does not exist in the port management information 306, the determination part 303 requests a creating part 307 to create a printing port.

The port management part 304 manages creation, changing and deletion of printing ports. The port management part 304 includes the creating part 307, a changing part 308 and a deletion part 309.

When receiving the creation request from the determination part 303, the creating part 307 creates a printing port, and stores in the port management part 306 the created printing port while associating the created printing port with the output destination information.

In the port management information 306, the printing port and the output destination information are stored while the printing port and the output destination information are associated with one another. Further, the printing port that is created by the creating part 307 and the output destination information that is set by the setting part 302 are added to the port management information 306.

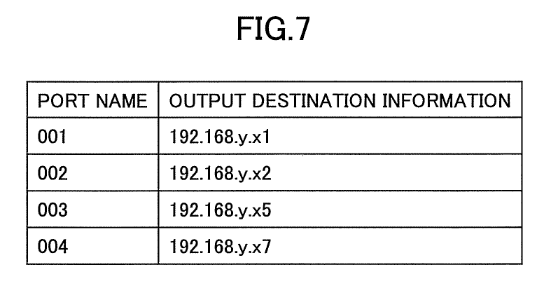

FIG. 7 shows one example of the port management information 306. For the output destination information newly set by the setting part 302, the creating part 307 creates the printing port, and the created printing port is added to the port management information 306 shown in FIG. 7. It is noted that in a case where the output destination information newly set by the setting part 302 already exists in the port management information 306, the creating part 307 does not create a printing port.

Returning to FIG. 4, the changing part 308 gives an instruction to the UI display part 301 to display a printing port management screen page on the display part 16, and receives a change of the printing port or the output destination information. Further, the deletion part 309 gives an instruction to the UI display part 301 to display the printing port management screen page on the display part 16, and deletes the printing port and the output destination information that are designated by the user.

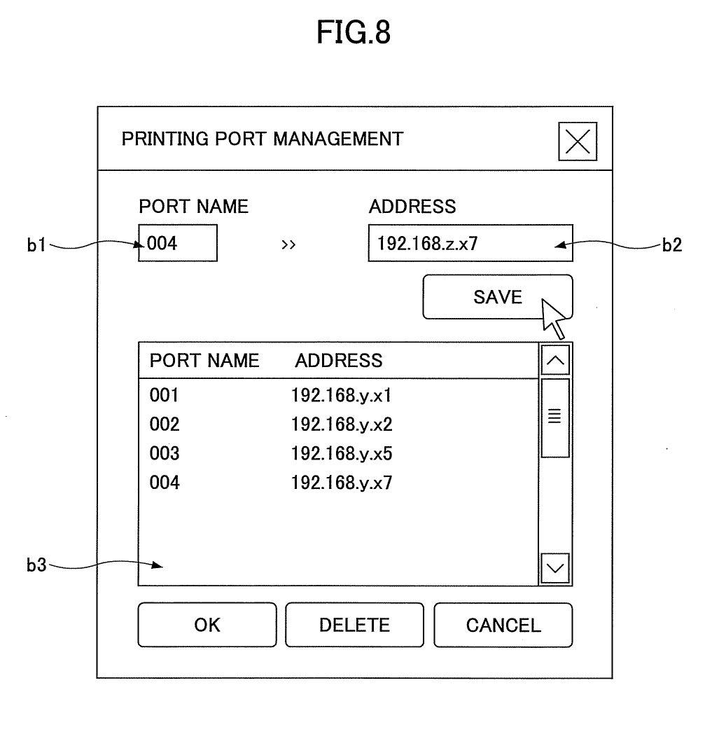

FIG. 8 shows an example of the printing port management screen page. Based on information input by the user from the printing port management screen page shown in FIG. 8, the port management part 304 changes the IP address, or creates or deletes the printing port.

In a case where a printing port is to be created in an example other than the above-described example of creating the printing port, the user inputs a new printing port name in a port edit box b1 and a new IP address in an address edit box b2, and presses a “SAVE” button on the printing port management screen page of FIG. 8. The creating part 307 detects the pressing of the “SAVE” button, and stores the input printing port name and IP address (output destination information) in the port management information 306.

Further, in a case where the IP address of the printing port is to be changed, the user selects the printing port from a list of a display area b3 shown in FIG. 8, changes the IP address from the address edit box b2, and presses the “SAVE” button. The changing part 308 detects the selection of the printing port from the list. Next, when the changing part 308 detects the “SAVE” button being pressed, the changing part 308 reflects the changed IP address in the port management information 306. Specifically, the changing part 308 updates the IP address in the port management information 306 corresponding to the selected printing port by the changed IP address.

At this time, the changing part 308 also changes the IP address in the job management information 305. Specifically, the changing part 308 searches the job management information 305 for the printing port for which the IP address has been changed, and updates the IP address corresponding to the printing port that has been searched for by the changed IP address.

Further, in a case where the printing port is to be deleted, the user selects the printing port from the list of the display area b3, and presses a “DELETE” button. The deletion part 309 detects the “DELETE” button being pressed, and deletes the selected printing port and the IP address corresponding to the printing port from the port management information 306.

Further, a configuration may be provided such that the creation, changing and deletion of the printing port are not completed unless an “OK” button is pressed. In this case, when the user presses a “CANCEL” button, the changed contents are discarded and the original state is returned to.

Further, FIG. 8 shows an example in which the user selects the printing port “004” for changing the IP address of the printing port “004”, inputs “192.168.z.x7” in the address edit box b2, and presses the “SAVE” button. When the user presses the “SAVE” button, the changing part 308 changes the IP address of the printing port “004” from “192.168.y.x7” into “192.168.z.x7”. A configuration may be provided such that when the user presses the “OK” button, the change is fixed. Further, a configuration may be provided such that when the user presses the “CANCEL” button, the changed contents are not stored, and therefore, the IP address of the printing port “004” is maintained as “192.168.y.x7”.

It is noted that the changing part 308 displays the job management information 305 on the display part 16 so that the user can change the printing port for the desired printing job. In this case, the changing part 308 detects the user's selection of the printing job included in the displayed job management information 305, urges the user to select the printing port from among the printing ports managed in the port management information 306, and changes the printing port corresponding to the selected printing job into the selected printing port.

The port monitor 40 (output part) outputs the page description language that is output from the spooler 50, to the printer apparatus (output destination) which is previously set, by using the Ethernet (registered trademark), USB (Universal Serial Bus) or such. As a specific example of the port monitor 40, one called “Standard TCP/IP Port” exists which is a port monitor to be used for a network printer of Windows (registered trademark).

The spooler 50 has storage areas for temporarily storing the printing jobs that are generated by an application(s) (software), and controls to output the once stored printing jobs to the printer apparatus(es) in sequence.

It is noted that the job management information 305 and the port management information 306 may be stored by the same storage part (RAM 12, for example), or may be stored by different storage parts. Further, as the output destination information, not only the IP address but also a printer name that can be uniquely identified may be used.

### <Operations>

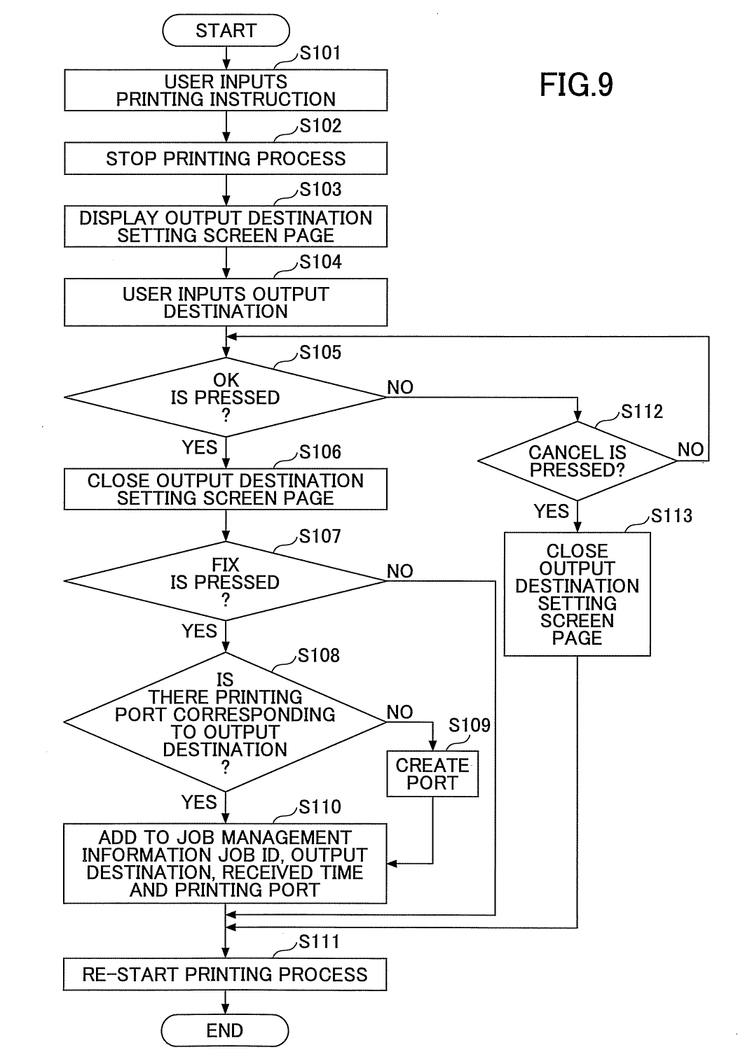

Next, operations of the information processing apparatus 1 in the embodiment 1 will be described. FIG. 9 shows a flowchart of a process of adding to the job management information 305 according to the embodiment 1.

In step S101, the user inputs a printing request by using application software. In step S102, the output destination changing application 30 stops a printing process. In step S103, the output destination changing application 30 displays the output destination setting screen page for the user to be able to change the output destination.

In step S104, the user selects the printing job for which the output destination is to be changed from the displayed output destination setting screen page, and inputs the output destination information in the output destination edit box.

In step S105, the output destination changing application 30 determines whether the user has pressed the “OK” button from the output destination setting screen page. When the determination result of step S105 is YES (“OK” button pressing detection), step S106 is proceeded to. When the determination result of step S105 is NO (“OK” button pressing not detection), step S112 is proceeded to.

In step S106, the output destination changing application 30 closes the output destination setting screen page.

In step S107, the output destination changing application 30 determines whether the “FIX” button has been pressed during steps S104 through S106. When the determination result of step S107 is YES (the FIX button has been pressed), step S108 is proceeded to. When the determination result of step S107 is NO (the FIX button has not been pressed), step S111 is proceeded to.

In step S108, the output destination changing application 30 determines whether the printing port corresponding to the output destination information (IP address) that has been input to the output destination edit box exists in the port management information 306. When the determination result of step S108 is YES (existing), step S110 is proceeded to. When the determination result of step S108 is NO (not existing), step S109 is proceeded to.

In step S109, the output destination changing application 30 creates a printing port.

In step S101, the output destination changing application 30 adds the job ID of the printing job, the output destination information, the printing port (i.e., the printing port created in step S109 or the printing port existing in the port management information 306 in step S108) and the received time of the printing job to the job management information 305.

In step S111, the information processing apparatus 1 transmits the printing jobs stored by the spooler 50 to the output destinations by using the printing ports, in sequence, printing job by printing job (starting of the printing process again).

In step S112, the output destination changing application 30 determines whether the “CANCEL” button has been pressed. When the determination result of step S112 is YES (CANCEL button pressing detection), step S113 is proceeded to. When the determination result of step S112 is NO (CANCEL button pressing not detection), step S105 is returned to.

In step S113, the output destination changing application 30 closes the output destination setting screen page.

Thus, the output destination changing application 30 manages the printing port corresponding to the printing job that is the printing request that has been input by the user, and therefore, by using the output destination changing application 30, it is possible to change the printing port if necessary.

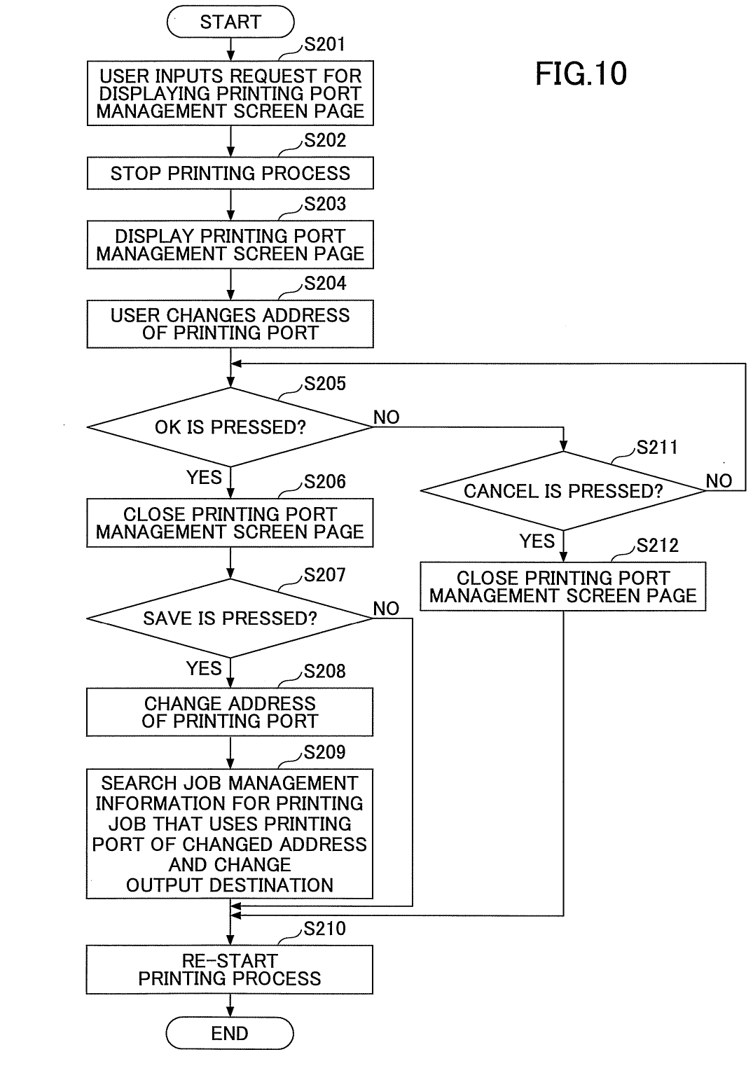

Next, a process of changing the IP address of the printing port in the embodiment 1 will be described. FIG. 10 shows a flowchart of one example of a process of changing the IP address of the printing port in the embodiment 1.

In step S201, the user inputs to display the printing port management screen page. In step S202, the output destination changing application 30 stops a printing process. In step S203, the output destination changing application 30 displays the port management screen page.

In step S204, the user changes the IP address of the printing port from the displayed printing port management screen page (see FIG. 8). Specifically, the user selects the printing port from the printing port management screen page, and changes the IP address in the address edit box. At this time, the output destination changing application 30 receives the input of the changed IP address.

In step S205, the output destination changing application 30 determines whether the user has pressed the “OK” button from the printing port management screen page. When the determination result of step S205 is YES (the OK button pressing detection), step S206 is proceeded to. When the determination result of step S205 is NO (the OK button pressing not detection), step S211 is proceeded to.

In step S206, the output destination changing application 30 closes the printing port management screen page.

In step S207, the output destination changing application 30 determines whether the “SAVE” button has been pressed during steps S204 through S206. When the determination result of step S207 is YES (the SAVE button having been pressed), step S208 is proceeded to. When the determination result of step S207 is NO (the SAVE button having not been pressed), step S210 is proceeded to.

In step S208, the output destination changing application 30 changes the IP address corresponding to the selected printing port, included in the port management information 306, into the output destination information (IP address) that has been input to the address edit box. Specifically, the IP address of the printing port that is managed by the operating system is changed into the IP address that is input by the user.

In step S209, the output destination changing application 30 searches the job management information 305 for the printing job that uses the printing port corresponding to the changed IP address, and changes the IP address of the printing job that has been searched for.

In step S210, the information processing apparatus 1 transmits the printing jobs stored by the spooler 50 to the output destinations by using the printing ports, in sequence, printing job by printing job (the printing process is started again).

In step S211, the output destination changing application 30 determines whether the “CANCEL” button has been pressed. When the determination result of step S211 is YES (the CANCEL button pressing detection), step S212 is proceeded to. When the determination result of step S211 is NO (the CANCEL button pressing not detection), step S205 is returned to.

In step S212, the output destination changing application 30 closes the printing port management screen page.

Thus, by using the output destination changing application 30, it is possible to change the output destination information of the printing job(s) corresponding to the printing port in a lump at any time by changing the IP address of the printing port.

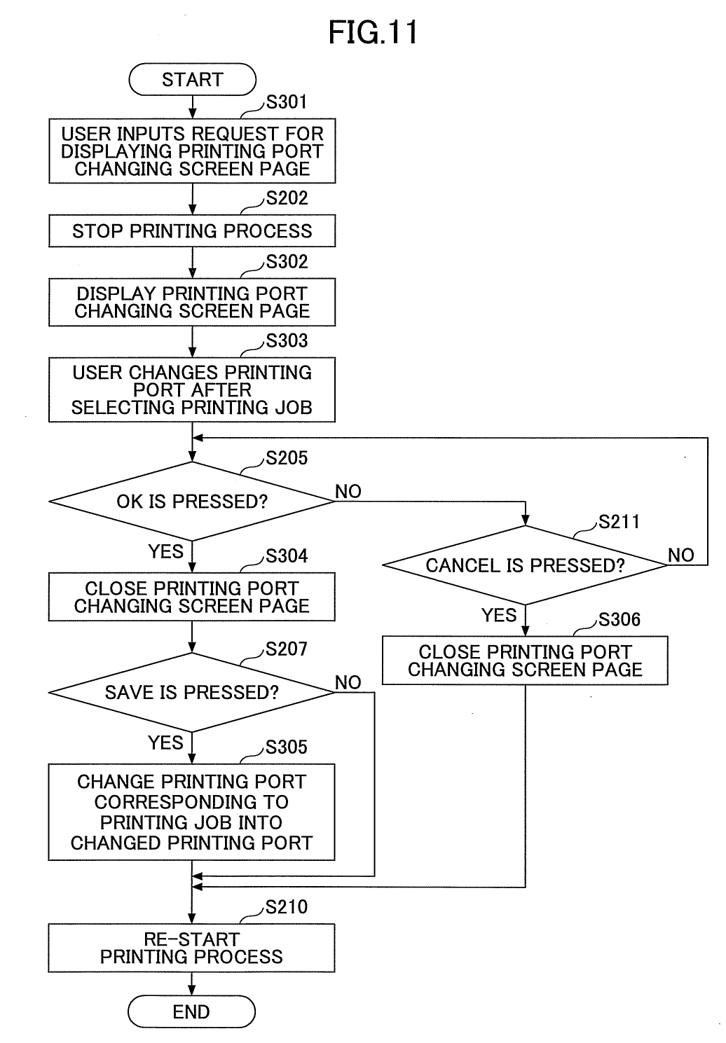

Next, a process of changing the printing port for the printing job in the embodiment 1 will be described. FIG. 11 shows a flowchart of one example of a process of changing the printing port for the printing job in the embodiment 1. As for steps shown in FIG. 11, the same reference numeral are given to steps that have the same processes as those of the steps shown in FIG. 10, and duplicate description therefor will be omitted.

In step S301, the user inputs to display a printing port changing screen page. The printing port changing screen page is such that the job IDs, the output destination information and the printing ports are displayed based on the job management information 305. Further, the printing port changing screen page is such that the printing job can be selected from the printing port changing screen page, and the printing port of the selected printing job can be changed to any one of the printing ports that the port management information 306 manages.

In step S302, the output destination changing application 30 displays the printing port changing screen page.

In step S303, the user changes the printing port from the printing port changing screen page. Specifically, the user selects the printing job from the printing port changing screen page, and changes the printing port in the printing port edit box (not shown). At this time, the output destination changing application 30 receives the input of the changed printing port. Further, a configuration may be provided such that the printing port to be input to the printing port edit box is selectable from the printing ports included in the port management information 306.

When a SAVE button is pressed after the printing port is thus changed, the output destination changing application 30 changes the printing port corresponding to the selected porting job, included in the job management information 305, into the printing port that has been input from the printing port edit box or selected from the printing ports included in the port management information 306, in step S305.

In step S306, when a CANCEL button is pressed, the output destination changing application 30 closes the printing port changing screen page.

Thus, by using the output destination changing application 30, it is possible to change the printing port corresponding to any printing job at any time.

Further, the output destination changing application 30 monitors the spooler 50, and switches the printing port if necessary at a time the printing job is output from the spooler 50 based on the job management information 305.

Thus, according to the embodiment 1, as a result of the printing job and the printing port being associated with one another, the output destination of the printing job can be managed. Further, according to the embodiment 1, by displaying the correspondence between the printing job and the printing port to the user, the user can determine which printing job is output to which output destination. Further, according to the embodiment 1, it is possible to change the IP address of the printing port or change the printing port at any time.

Further, it is possible to embody the process contents described above for the embodiment 1 as a computer program, cause a computer to execute the computer program, and thus, cause the information processing apparatus 1 to carry out the process contents. Further, it is possible to record the computer program in a computer readable information recording medium, cause the computer to read the computer program from the computer readable information recording medium and thus, cause the information processing apparatus 1 to carry out the process contents.

The present invention is not limited to the specifically disclosed embodiments, and variations and modifications may be made without departing from the scope of the present invention.

The present application is based on Japanese priority application No. 2009-198515 filed Aug. 28, 2009, the entire contents of which are hereby incorporated herein by reference.

What is claimed is:

1. A non-transitory computer readable information recording medium storing a program which, when executed by a computer processor, carries out:
setting, for a printing request that is obtained from a printer driver, output destination information used to identify an output destination to which the printing request is output;
determining whether a printing port that corresponds to the output destination information that has been set exists based on port management information that associates the printing port with the output destination information;
creating a printing port when the determining determines that no printing port that corresponds to the output destination information exists; and
storing in job management information the printing port that corresponds to the output destination information or the created printing port, the printing request and the output destination information in such a manner that the printing port, the printing request and the output destination information are associated with each other.

2. The computer readable information recording medium as claimed in claim 1, wherein the program, when executed by a computer processor, further carries out:
changing the output destination information corresponding to the printing port included in the port management information into changed output destination information; and
searching the job management information for the printing job, for which the output destination information of the printing port included in the port management information has been changed to the changed output destination information, and changing in the job management information the output destination information corresponding to the printing job that has been searched for into the changed output destination information.

3. The computer readable information recording medium as claimed in claim 1, wherein the program, when executed by a computer processor, further carries out:
displaying the job management information on a display part;
receiving a selection of the printing request included in the job management information displayed on the display part, and receiving an input or a selection of the printing port included in the port management information; and
changing the printing port included in the job management information, which printing port corresponds to the selected printing request, into the input or selected printing port.

4. An information processing apparatus in which a printer driver is installed, comprising:
a setting part that sets, for a printing request that is obtained from the printer driver, output destination information used to identify an output destination to which the printing request is output;
a determination part that determines whether a printing port that corresponds to the output destination information exists based on port management information that associates the printing port with the output destination information;
a storage part that stores job management information in which the printing port, the printing request and the output destination information are associated with each other; and
a creation part that creates a printing port when the determination part determines that no printing port that corresponds to the output destination information exists, wherein
the storage part stores in the job management information the printing port that corresponds to the output destination information or the created printing port, the printing request and the output destination information in such a manner the printing port, the printing request and the output destination information are associated with each other.

5. The information processing apparatus as claimed in claim 4, further comprising:
a first changing part that changes the output destination information corresponding to the printing port included in the port management information into changed output destination information; and
a second changing part that searches the job management information for the printing job, for which the output destination information of the printing port included in the port management information has been changed to the changed output destination information, and changes the output destination information corresponding to the printing job that has been searched for into the changed output destination information in the job management information

6. The information processing apparatus as claimed in claim 4, further comprising:
a display part that displays the job management information on a display part;
a reception part that receives a selection of the printing request included in the job management information displayed on the display part, and receives an input or a selection of the printing port included in the port management information; and
a changing part that changes the printing port included in the job management information, which printing port corresponds to the selected printing request, into the input or selected printing port.
